(19) United States
(12) Patent Application Publication
(10) Pub. No.: US 2015/0065064 A1
(43) Pub. Date: Mar. 5, 2015

(54) ACTIVE INTERFERENCE CANCELLATION IN ANALOG DOMAIN

(71) Applicant: QUALCOMM Incorporated, San Diego, CA (US)

(72) Inventors: Insoo Hwang, San Diego, CA (US); Bongyong Song, San Diego, CA (US); Samir Salib Soliman, Poway, CA (US)

(21) Appl. No.: 14/015,684

(22) Filed: Aug. 30, 2013

(51) Int. Cl. H04B 1/10

(52) U.S. Cl. CPC H04B 1/1036
USPC 455/78

(57) ABSTRACT

A method of performing interference cancellation (IC) in a communication device having a plurality of transmitters and a plurality of receivers includes detecting a co-existence issue between a first transmitter and a first receiver; selecting the first transmitter for providing an input signal to IC circuit; selecting the first receiver, wherein each of the receivers has a corresponding filter, the first receiver having a filter for filtering a signal received by the first receiver to provide a first filtered signal; configuring the IC circuit based on parameters of the co-existence issue; generating an output signal based on the input signal and the parameters; selecting a filter, based on the filter of the first receiver, the selected filter configured to filter the output signal to provide a second filtered signal; and generating a cancellation signal based on the first and second filtered signals.

### BACKGROUND

1. Field

The disclosure relates generally to the field of interference cancellation systems and methods, and, in particular, to systems and methods for cancelling interference in the analog domain produced by multiple radios operating on the same, adjacent, harmonic/sub-harmonic, or intermodulation product frequencies.

2. Background

Advanced wireless devices have multiple radios (e.g., WWAN, WLAN, WPAN, GPS/GLONASS, etc.) that operating on the same, adjacent, or harmonic/sub-harmonic frequencies. Various combinations of radios cause co-existence issues due to the relative frequencies. In particular, when one radio is actively transmitting at or close to the same frequency and at a same time that another radio is receiving, the transmitting radio can cause interference to the receiving radio. For example, same band interference may occur between Bluetooth (WPAN) and 2.4 GHz WiFi (WLAN); adjacent band interference between WLAN and LTE band 7, 40, 41; harmonic/sub-harmonic interference may occur between 5.7 GHz ISM and 1.9 GHz PCS; and an intermodulation issue may occur between 7xx MHz and a GPS receiver).

Active interference cancellation (AIC) cancels interference between a transmitter radio and a receiver radio by matching gain and phase of a wireless coupling path signal and in a wired AIC path, as shown in FIG. 6, where dₜ is a transmitted signal from the transmitter (aggressor) radio, and h_{c} is the coupling channel (wireless coupling path signal) from the transmitter radio to the receiver (victim) radio.

AIC may be implemented with respect to RF (radio frequency), BB (baseband), or both RF/BB. AIC in BB only shows limited cancellation performance because the coupling path signal is much stronger than the desired signal strength, easily resulting in the saturation of an LNA (low-noise amplifier) and an ADC (analog-to-digital converter). AIC in RF provides better cancellation performance. Prior art RF AIC techniques include difference calibration methods, such as direct channel estimation and cancellation method, binary search the coupling phase, and LMS (least mean squares)-based adaptive filtering methods. The LMS-based methods can further be categorized into analog LMS and digital LMS methods, depending on where the LMS coefficient is generated. However, interference cancellation performance is limited because of delay mismatch between the wireless coupling path and the wired AIC path. In particular, the use of filters in the AIC path increases the group delay significantly relative to the coupling path.

Moreover, existing solutions are generally specific to one particular co-existence combination (e.g., only for the combination of Bluetooth and WLAN) requiring a different solution for each co-existence issue.

### SUMMARY

A method of performing interference cancellation in a communication device having a plurality of transmitters and a plurality of receivers includes, but is not limited to any one or combination of: detecting a co-existence issue between a first transmitter of the plurality of transmitters and a first receiver of the plurality of receivers; selecting the first transmitter for providing an input signal to an interference cancellation (IC) circuit; selecting the first receiver, wherein each of the receivers has a corresponding filter, the first receiver having a filter for filtering a signal received by the first receiver to provide a first filtered signal; configuring the IC circuit based on parameters of the co-existence issue; generating, at the IC circuit, an output signal based on the input signal and the parameters of the co-existence issue; selecting a filter, based on the filter of the first receiver, configured to receive the output signal of the IC circuit, the selected filter configured to filter the output signal to provide a second filtered signal; and generating a cancellation signal based on the first filtered signal and the second filtered signal to reduce interference caused by the first transmitter on the first receiver.

In various embodiments, the selected filter is selected to be identical to the filter of the first receiver.

In various embodiments, the selected filter is selected to provide a delay on an IC path along which the IC circuit is located that is the same as a delay on a coupling path between an antenna of the first transmitter and an antenna of the first receiver.

In various embodiments, the filter of the first receiver may comprise at least one of a band pass filter, a duplexer, and a notch filter.

In various embodiments, the selected filter may comprise at least one of a band pass filter, a duplexer, and a notch filter.

In various embodiments, the IC circuit may comprise an adaptive filter.

In some embodiments, the adaptive filter may comprise a lease mean squares (LMS) adaptive filter.

In further embodiments, the LMS adaptive filter may comprise an analog-controlled analog LMS adaptive filter.

In further embodiments, the LMS adaptive filter may comprise a digitally-controlled analog LMS adaptive filter.

In some embodiments, the adaptive filter may comprise a single-tap filter.

In various embodiments, the selecting a filter comprises selecting a filter from among a plurality of filters.

In various embodiments, the selecting a filter comprises configuring the filter based on the filter of the first receiver.

In various embodiments, the first transmitter and the first receiver are selected based on the co-existence issue between the first transmitter and the first receiver.

In various embodiments, the method further includes: detecting a second co-existence issue between the first transmitter of the plurality of transmitters and a second receiver of the plurality of receivers; selecting the first transmitter for providing a second input signal to the IC circuit; selecting the second receiver, the second receiver having a filter for filtering a signal received by the second receiver to provide a third filtered signal; configuring the IC circuit based on the parameters of the second co-existence issue; generating, at the IC circuit, a second output signal based on the second input signal and the parameters of the second co-existence issue; selecting a filter, based on the filter of the second receiver, from among the plurality of filters configured to receive the second output signal of the IC circuit, the selected filter configured to filter the second output signal to provide a fourth filtered signal; and generating a cancellation signal based on the third filtered signal and the fourth filtered signal to reduce interference caused by the first transmitter on the second receiver.

In various embodiments, the method further includes: detecting a second co-existence issue between a second transmitter of the plurality of transmitters and a second receiver of the plurality of receivers; selecting the second transmitter for providing a second input signal to the IC circuit; selecting the second receiver, the second receiver having a filter for filtering a signal received by the second receiver to provide a third filtered signal; configuring the IC circuit based on the parameters of the second co-existence issue; generating, at the IC circuit, a second output signal based on the second input signal and the parameters of the second co-existence issue; selecting a filter, based on the filter of the second receiver, from among the plurality of filters configured to receive the second output signal of the IC circuit, the selected filter configured to filter the second output signal to provide a fourth filtered signal; and generating a cancellation signal based on the third filtered signal and the fourth filtered signal to reduce interference caused by the second transmitter on the second receiver.

In various embodiments, the first transmitter transmits signals on a frequency within a first frequency band. The first receiver receives signals at a frequency within a second frequency band. The first frequency band at least partially overlaps the second frequency band.

In various embodiments, the first transmitter transmits signals on a frequency within a first frequency band. The first receiver receives signals at a frequency within a second frequency band. The first frequency band is adjacent the second frequency band.

In various embodiments, the first transmitter transmits signals at a frequency within a first frequency band. The first receiver receives signals at a frequency within a second frequency band. The first frequency band is a non-adjacent lower frequency band. In some embodiments, the first frequency band includes a sub-harmonic frequency of the second frequency band.

In various embodiments, the first transmitter transmits signals at a frequency within a first frequency band. The first receiver receives signals at a frequency within a second frequency band. The first frequency band includes a non-adjacent higher frequency band. In some embodiments, the first frequency band includes a harmonic frequency of the second frequency band.

In various embodiments, the method further includes detecting an intensity of the interference caused by the first transmitter on the first receiver. The co-existence issue is not detected if the intensity is below a predetermined threshold.

In various embodiments, at least one receiver of the plurality of receivers is configured to receive navigation signals.

In various embodiments, the detecting a co-existence issue comprises measuring an interference level at the first receiver.

In some embodiments, the interference level is based on (i) a frequency separation between a transmit channel of the first transmitter and receive channel of the first receiver and (ii) transit power of the transmitter.

In further embodiments, the detecting a co-existence issue comprises comparing the interference level with a pre-defined table.

In various embodiments, the detecting a co-existence issue comprises measuring transmission information obtained at the transmitter.

In various embodiments, the detecting a co-existence issue comprises detecting a co-existence issue based on a pre-defined table.

In various embodiments, the detecting a co-existence issue comprises measuring transmission information obtained at the transmitter.

In various embodiments, the method is not performed if the co-existence issue is not detected.

An apparatus for reducing interference in a communication device having a plurality of transmitters and a plurality of receivers includes, but is not limited to, means for detecting a co-existence issue between a first transmitter of the plurality of transmitters and a first receiver of the plurality of receivers; means for selecting the first transmitter for providing an input signal to an interference cancellation (IC) circuit; means for selecting the first receiver, wherein each of the receivers has a corresponding filter, the first receiver having a filter for filtering a signal received by the first receiver to provide a first filtered signal; means for configuring the IC circuit based on parameters of the co-existence issue; means for generating, at the IC circuit, an output signal based on the input signal and the parameters of the co-existence issue; means for selecting a filter, based on the filter of the first receiver, configured to receive the output signal of the IC circuit, the selected filter configured to filter the output signal to provide a second filtered signal; and means for generating a cancellation signal based on the first filtered signal and the second filtered signal to reduce interference caused by the first transmitter on the first receiver.

A computer program product for reducing interference in a communication device having a plurality of transmitters and a plurality of receivers include a computer-readable storage medium comprising code for (but not limited to): detecting a co-existence issue between a first transmitter of the plurality of transmitters and a first receiver of the plurality of receivers; selecting the first transmitter for providing an input signal to an interference cancellation (IC) circuit; selecting the first receiver, wherein each of the receivers has a corresponding filter, the first receiver having a filter for filtering a signal received by the first receiver to provide a first filtered signal; configuring the IC circuit based on parameters of the co-existence issue; generating, at the IC circuit, an output signal based on the input signal and the parameters of the co-existence issue; selecting a filter, based on the filter of the first receiver, configured to receive the output signal of the IC circuit, the selected filter configured to filter the output signal to provide a second filtered signal; and generating a cancellation signal based on the first filtered signal and the second filtered signal to reduce interference caused by the first transmitter on the first receiver.

A system for performing interference cancellation in a communication device includes, but is not limited to, a demultiplexer, an input multiplexer, an output de multiplexer, and a summer. The input multiplexer (MUX) configured to select a transmitter from among a plurality of transmitters. The interference cancellation (IC) circuit is configured to receive an input signal from the selected transmitter of the plurality of transmitters to generate an output signal. The demultiplexer (DEMUX) is configured to select a receiver from among a plurality of receivers. Each of the receivers is associated with a corresponding filter. The filter of the selected receiver is for filtering a signal received by the selected receiver to provide a first filtered signal. The DEMUX is configured to select a filter from among a plurality of filters, based on the filter of the selected receiver. The selected filter is for filtering the output signal to provide a second filtered signal. The summer is configured to combine the first filtered signal and the second filtered signal to provide a cancellation signal to reduce interference caused by the selected transmitter on the selected receiver.

A system for performing interference cancellation in a communication device includes, but is not limited to, a plurality of receiver filters, an interference cancellation circuit, a plurality of transmitter filters, and a summer. Each of the receiver filters is associated with a corresponding receiver of the plurality of receivers. The filter of a selected receiver is for filtering a signal received by the selected receiver to provide a first filtered signal. The interference cancellation (IC) circuit is configured to receive an input signal from a selected transmitter of the plurality of transmitters to generate an output signal. A selected transmitter filter is for filtering the output signal to provide a second filtered signal. The selected transmitter filter is selected from among the plurality of filters based on the filter of the selected receiver. The summer is configured to combine the first filtered signal and the second filtered signal to provide a cancellation signal to reduce interference caused by the selected transmitter on the selected receiver.

### BRIEF DESCRIPTION OF THE DRAWINGS

FIG. 1 is a block diagram illustrating an environment that includes a device according to various embodiments of the disclosure.

FIG. 2 is a block diagram of an illustrative hardware configuration for an apparatus employing a processing system according to various embodiments of the disclosure.

FIG. 3 is a portion of a communication system according to various embodiments of the disclosure.

FIG. 4 is a diagram of a communication system according to various embodiments of the disclosure.

FIGS. 5A-5B are flow charts of a method according to various embodiments of the disclosure.

FIG. 6 is a block diagram of an active interference cancellation system.

### DETAILED DESCRIPTION

Various embodiments relate to methods and systems for cancelling interference produced by multiple radios (transceivers) operating on the same, adjacent, harmonic/sub-harmonic frequencies, or intermodulation product frequencies. In particular embodiments, an interference-cancellation system is adaptable for different radio combinations. For instance, for a co-existence issue caused by a first combination of radios, the transmitting radio (e.g., WiFi) may be selected for an input of an interference cancellation (IC) circuit and the receiving radio (e.g., Bluetooth) may be selected for the output of the IC circuit. For a co-existence issue caused by a second (different) combination of radios, the transmitting radio (e.g., WiFi) may be selected for the input of the IC circuit and the receiving radio (e.g., LTE band 7) may be selected for the output of the IC circuit. It should be noted that the terms cancellation (as in interference cancellation) and variants thereof may be synonymous with reduction, mitigation, and/or the like in that at least some interference is reduced.

In various embodiments, for a given co-existence issue, systems and methods include two identical filters (e.g., similar characteristics): a filter in a wireless coupling path (along which a signal transmitted by an aggressor radio interferes with a victim radio) and a filter in an IC path (along which the IC circuit is provided) to minimize delay (and/or gain) mismatch between the two paths. In various embodiments, the IC circuit includes a digitally-controlled analog least mean squares (LMS) adaptive filter or an analog-controlled analog LMS adaptive filter to match gain in the IC path with gain in the wireless coupling path.

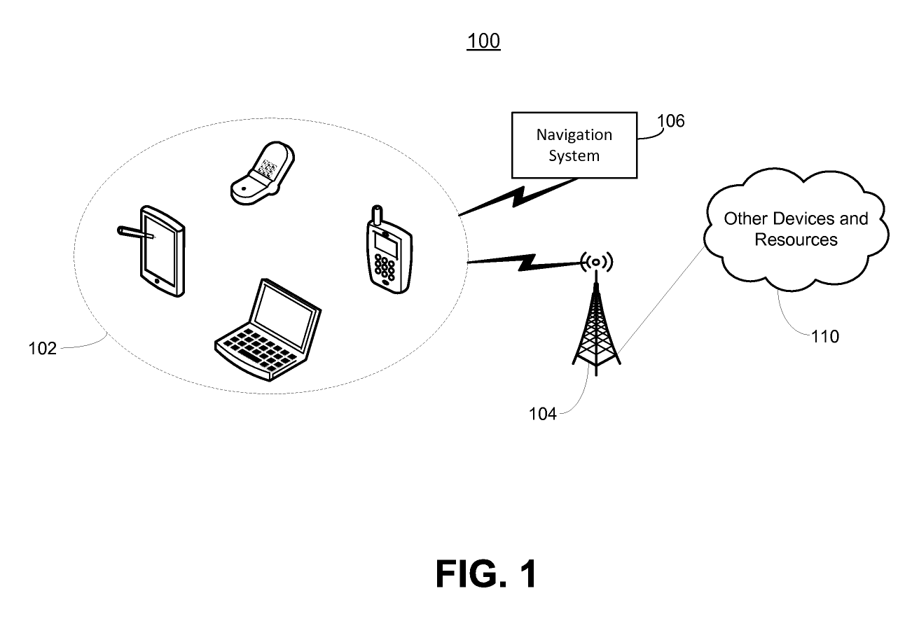

FIG. 1 is a block diagram illustrating an environment 100 that includes a device 102. The environment 100 may be representative of any system(s) or a portion thereof that may include at least one device 102 enabled to transmit and/or receive wireless signals to/from at least one wireless system 104. The device 102 may, for example, include a mobile device or a device that while movable is primarily intended to remain stationary. The device 102 may also include stationary devices (e.g., desktop computer) enabled to transmit and/or receive wireless signals. Thus, as used herein, the terms “device” and “mobile device” may be used interchangeably as each term is intended to refer to any single device or any combinable group of devices that may transmit and/or receive wireless signals.

In various embodiments, the device 102 may include a mobile device such as a cellular phone, a smart phone, a personal digital assistant, a portable computing device, a navigation device, a tablet, and/or the like or any combination thereof. In other embodiments, the device 102 may take the form of a machine that is mobile or stationary. In yet other embodiments, the device 102 may take the form of one or more integrated circuits, circuit boards, and/or the like that may be operatively enabled for use in another device.

The device 102 may include at least one radio (also referred to as a transceiver). The terms “radio” or “transceiver” as used herein refers to any circuitry and/or the like that may be enabled to receive wireless signals and/or transmit wireless signals. In particular embodiments, two or more radios may be enabled to share a portion of circuitry and/or the like (e.g., a processing unit, memory, etc.). That is the terms “radio” or “transceiver” may be interpreted to include devices that have the capability to both transmit and receive signals, including devices having separate transmitters and receivers, devices having combined circuitry for transmitting and receiving signals, and/or the like.

In some embodiments, the device 102 may include a first radio enabled to receive and/or transmit wireless signals associated with at least a first network of a wireless system 104 and a second radio that is enabled to receive and/or transmit wireless signals associated with at least a second network of the wireless system 104 and/or at least one navigation system 106 (e.g., a satellite positioning system and/or the like).

The wireless system 104 may, for example, be representative of any wireless communication system or network that may be enabled to receive and/or transmit wireless signals. By way of example but not limitation, the wireless system 104 may include one or more of a wireless wide area network (WWAN), a wireless local area network (WLAN), a wireless personal area network (WPAN), a wireless metropolitan area network (WMAN), a Bluetooth communication system, WiFi communication system, Global System for Mobile communication (GSM) system, Evolution Data Only/Evolution Data Optimized (EVDO) communication system, Ultra Mobile Broadband (UMB) communication system, Long Term Evolution (LTE) communication system, Mobile Satellite Service—Ancillary Terrestrial Component (MSS-ATC) communication system, and/or the like.

The wireless system 104 may be enabled to communicate with and/or otherwise operatively access other devices and/or resources as represented simply by cloud 110. For example, the cloud 110 may include one or more communication devices, systems, networks, or services, and/or one or more computing devices, systems, networks, or services, and/or the like or any combination thereof.

The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and/or the like. A CDMA network may implement one or more radio access technologies (RATs) such as cdma2000, Wideband CDMA (W-CDMA), to name just a few radio technologies. Here, cdma2000 may include technologies implemented according to IS-95, IS-2000, and IS-S56 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include (but not limited to) a Bluetooth network, an IEEE 802.15x, for example.

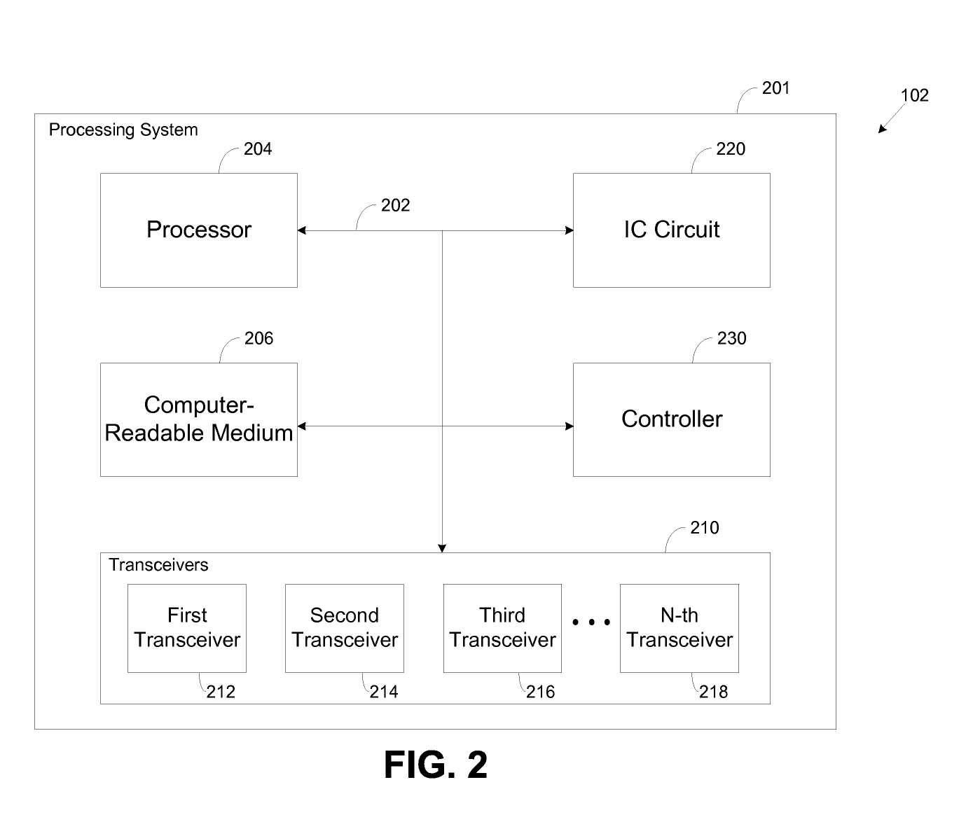

FIG. 2 is a block diagram of an illustrative hardware configuration for an apparatus, such as the device 102, employing a processing system 201 according to various embodiments of the disclosure, including (but not limited to) the embodiments of FIGS. 1 and 3-5B. In this example, the processing system 201 may be implemented with a bus architecture represented generally by bus 202. The bus 202 may include any number of interconnecting buses and bridges depending on the specific application of the processing system 201 and the overall design constraints. The bus 202 links together various circuits including one or more processors, represented generally by the processor 204, and computer-readable media, represented generally by the computer-readable medium 206. The bus 202 may also link various other circuits such as timing sources, peripherals, voltage regulators, and power management circuits, which are well known in the art, and therefore, will not be described any further. A bus interface 208 provides an interface between the bus 202 and a plurality of transceivers 210 (also referred to as radios). Each of the transceivers 210 allows for communicating with various other apparatus over a transmission medium.

A processor 204 is responsible for managing the bus 202 and general processing, including the execution of software stored on computer-readable storage medium 206. The software, when executed by the processor 204, causes the processing system 201 to perform the various functions described in the disclosure for any particular apparatus. The computer readable storage medium 206 may also be used for storing data that is manipulated by the processor 204 when executing software.

In various embodiments, the processing system 201 includes an interference cancellation (IC) circuit 220 and a controller 230. The IC circuit 220 is configured to cancel interference produced by the transceivers 210 that are operating on the same, adjacent, or harmonic/sub-harmonic frequencies. The controller 230 may be as a microcontroller, a microprocessor, computer, state machine, or other programmable device. The controller 230 is coupled to the IC circuit 220. The controller 230 executes one or more algorithms and/or include control logic (e.g., as stored on the computer-readable storage medium 206) for optimizing the reduction of interference by the IC circuit 220. In particular, the controller 230 adjusts the settings of the IC circuit 220 to adjust the amplitude, phase, and/or delay of an input signal to generate an output. In some embodiments, the controller may be the processor 204.

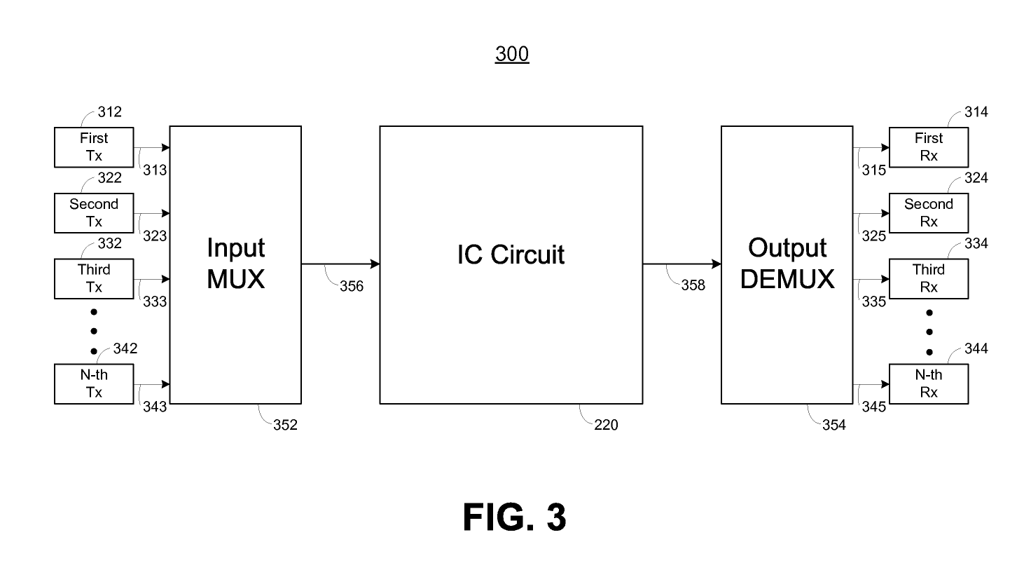

FIG. 3 illustrates a portion of an interference management system 300 that is at least a part of and/or implemented with the processing system 201 (e.g., FIG. 2). That is, the interference management system 300 may be implemented in the device 102 (e.g., FIGS. 1-2).

With reference to FIGS. 1-3, in various embodiments, the plurality of transceivers 210 may include n transceivers (e.g., two transceivers, three transceivers, etc.), such as, for example (but not limited to), a first transceiver 212, a second transceiver 214, a third transceiver 216, to an n-th transceiver 218. The first transceiver 212 may include a first transmitter 312 and a first receiver 314. The second transceiver 214 may include a second transmitter 322 and a second receiver 324. The third transceiver 216 may include a third transmitter 332 and a third receiver 334. The n-th transceiver 218 may include an n-th transmitter 342 and an n-th receiver 344. Depending on which transmitters are active (e.g., transmitting) and which receivers are active (e.g., receiving), any number of co-existence issues may occur.

Each of the transceivers 210 may operate according to various parameters, such as a respective frequency, radio frequency circuits with group delays, coupling channel gains to other transceivers, and/or the like. For instance, the first transceiver 212 may operate at a first frequency f1 with a first delay d1, the second transceiver 214 may operate at a second frequency f2 with a second delay d2, the third transceiver 216 may operate at a third frequency f3 with a third delay d3, and the n-th transceiver 218 may operate at an n-th frequency fn with an n-th delay d2. The first transceiver 212 may have a coupling channel gain h12 to the second transceiver 214, a coupling channel gain h13 to the third transceiver 216, and a coupling channel gain h1n to the n-th transceiver 218, respectively. Other transceivers 210 may have different coupling channel gains to various transceivers 210.

In various embodiments, the processing system 201 is configured to reduce interference produced among transceivers of the plurality of transceivers 210, for example, operating on the same, adjacent, harmonic, or sub-harmonic frequencies. In particular embodiments, the processing system 201 is configured to be adaptable for different transceiver combinations. That is, the processing system 201 is configured to cancel interference based on the co-existence issue caused by the current combination of transceivers 210. For instance, for a first co-existence issue (e.g., at time T1) caused by a first combination of transceivers 210, such as the first transmitter 312 (e.g., WiFi transmitter) and the second receiver 324 (e.g., Bluetooth receiver), the processing system 201 (e.g., via the controller 230) may select from among the transmitters and the receivers, the first transmitter 312 for providing an input to the IC circuit 220 and the second receiver 324 for receiving an output of the IC circuit 220. Accordingly, interference caused by an aggressor transceiver (e.g., the first transmitter 312) upon a victim transceiver (e.g., the second receiver 324) can be reduced. In this case, if the coupling channel gain from the aggressor transceiver to the victim transceiver is −10 dB (e.g., due to separation of two antennas), then the IC circuit 220 may need to match this gain for successful IC. For a second co-existence issue (e.g., at time T2) caused by a second (different) combination of transceivers, such as the first transmitter 312 (e.g., WiFi transmitter) and the third receiver 334 (e.g., LTE band 7), the processing system 201 (e.g., via the controller 230) may select from among the transmitters and the receivers, the first transmitter 312 for providing an input to the IC circuit 220 and the third receiver 334 for receiving an output of the IC circuit 220. Accordingly, interference caused by an aggressor transceiver (e.g., the first transmitter 312) upon a victim transceiver (e.g., the third receiver 334) can be reduced. According to various embodiments, in such a case, if the coupling channel gain from the aggressor transceiver to the victim transceiver is −50 dB (e.g., due to separation two antennas and band pass filtering at the victim transceiver), then the IC circuit 220 may need to match this gain for successful IC.

In various embodiments, the system 300 is configured to select the transceivers (e.g., one or more transmitters and one or more receivers) associated with a co-existence issue. In particular embodiments, the controller 230 or the like selects the transceivers causing a co-existence issue for processing by the IC circuit 220, for example, in response to detection of the co-existence issue between the at least two transceivers. For instance, in some embodiments, the transmitters 312, 322, 332, 342 may be coupled to an input multiplexer (MUX) 352 to receive corresponding signals 313, 323, 333, 343 from the transmitters 312, 322, 332, 342. The input multiplexer 352 is coupled to the IC circuit 220 to allow the input multiplexer 352 to select (e.g., as controlled by the controller 230) one of the signals 313, 323, 333, 343 from one of the transmitters 312, 322, 332, 342 as input signal 356 to the IC circuit 220.

The receivers 314, 324, 334, 344 may be coupled to an output multiplexer 354 to receive corresponding signals 315, 325, 335, 345 from the output multiplexer 354. The output multiplexer 354 is coupled to the IC circuit 220 to allow the output multiplexer 354 to select (e.g., as controlled by the controller 230) one of the receivers 314, 324, 334, 344 to receive an output signal 358 from the IC circuit 220.

For example, for a co-existence issue caused by a combination of transceivers, such as the first transmitter 312 (e.g., WiFi transmitter) and the third receiver 334 (e.g., LTE band 7), the controller 230 may select from among the transmitters, the first transmitter 312 for providing the input signal 356 to the IC circuit 220, and the controller 230 may select from among the receivers, the third receiver 334 for receiving the output signal 358 from the IC circuit 220. Likewise, in response to detecting a different co-existence issue caused by a different combination of the transceivers 210, the controller 230 may select the transceivers causing the different co-existence issue. In some embodiments, the controller 230 may activate the IC circuit 220, which may be deactivated or in a reduced power state, in response to detecting a co-existence issue.

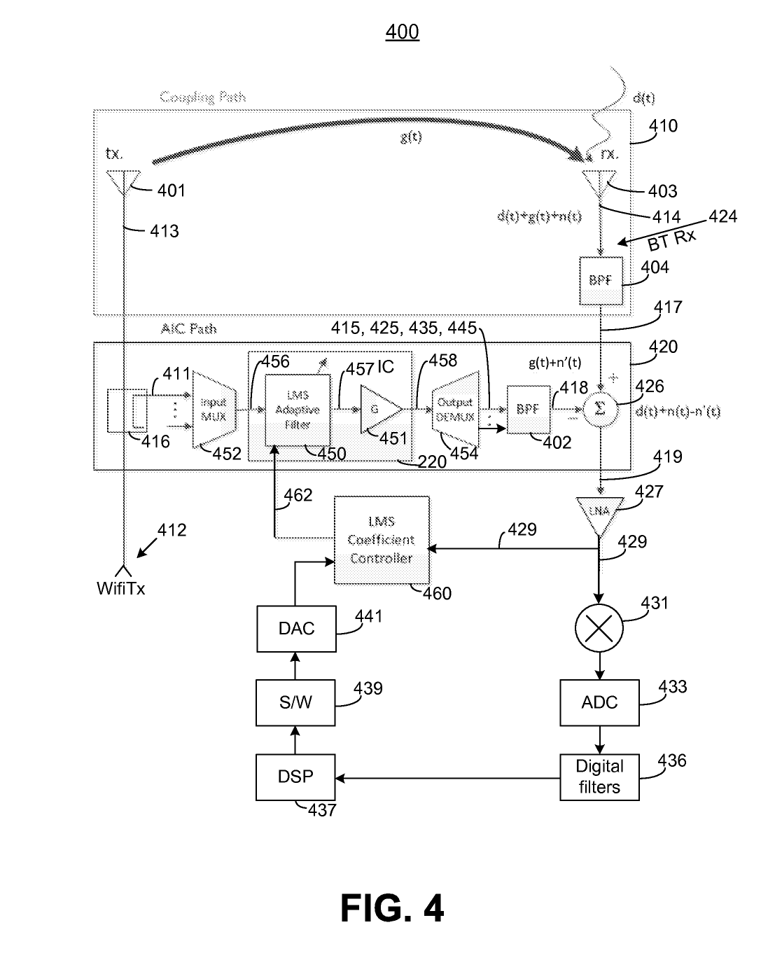

FIG. 4 is a functional block diagram of a communication system 400 employed with the device 102 (e.g., FIGS. 1-2) and/or the processing system 201 and may implement the features and methods of such. For reference, the system 400 includes a coupling path 410 along which a signal transmitted by an aggressor radio interferes with a victim radio and an IC path 420 along which the IC circuit 220 is provided to generate a cancellation signal to reduce interference caused by the aggressor radio upon the victim radio.

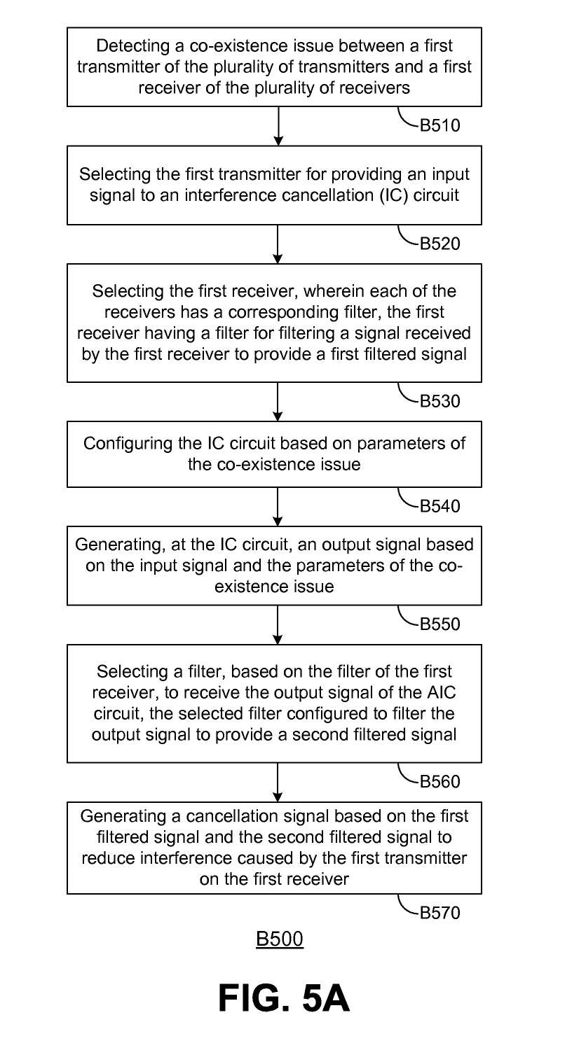

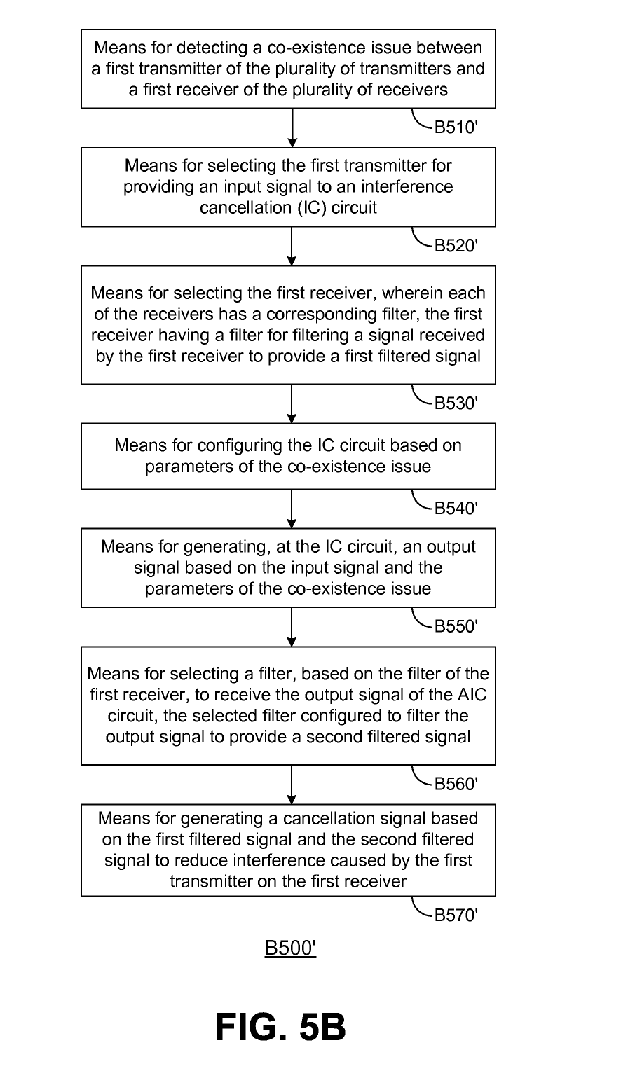

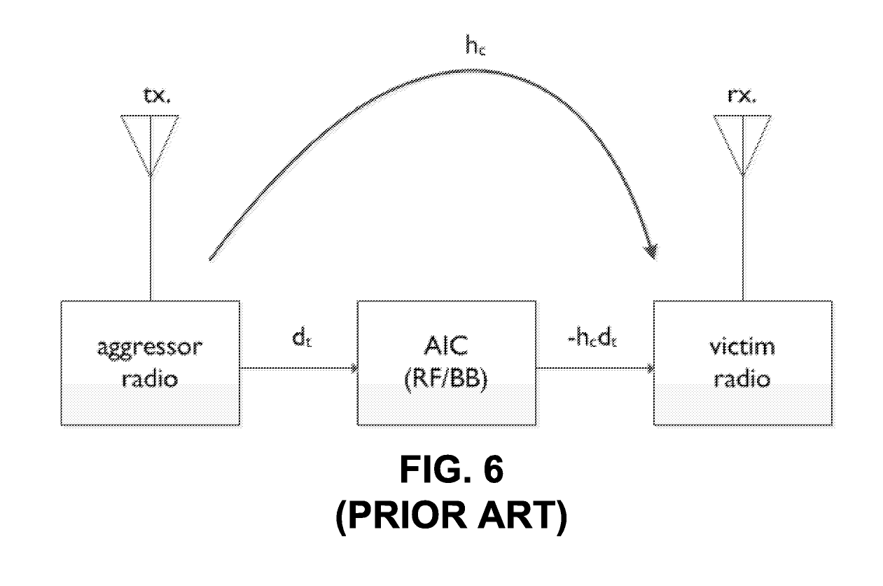

FIG. 5A illustrates a method B500 of interference management, for example for reduction or cancellation of such interference, according to various embodiments of the disclosure. With reference to FIGS. 1-5A, the method B500 may be performed, for example, by the communication system 400 (e.g., the IC circuit 220, the controller 230, etc.).

In various embodiments, at block B510, the controller 230 is configured to detect a co-existence issue between at least two of the transceivers 210. The controller 230, for instance, may detect a co-existence issue when at least a transmitter (aggressor transmitter) and a receiver (victim receiver) of the at least two transceivers 210 are active (e.g., transmitting/receiving) at once. In particular embodiments, a co-existence issue may be detected when the transmitter and the receiver are candidates for co-existence issues (e.g., as provided in a pre-defined look-up table or database). For instance, a co-existence issue may be detected between a first transmitter 412 (which may correspond, for example, to one of the transmitters 312, 322, 332, 342) and a first receiver 424 (which may correspond, for example, one of the receivers 314, 324, 334, 344).

In some embodiments, the candidates may be provided in a look-up table or other database of known transceiver combinations that cause co-existence issues. Accordingly, when a combination of active transceivers is detected that appears in the table or database, a co-existence issue may be detected. In other embodiments, a sensor may be provided for sensing, measuring, or otherwise detecting interference, such as an intensity or magnitude (level) of the interference, on a transceiver (e.g., receiver) or a symptom of interference (e.g., de-sense level), such as a reduced receiving signal or the like (e.g., reduced receiving rate, increased noise, etc.) by the transceiver. In some embodiments, transmission information (e.g., by a transmitter) may be sensed, measured, or otherwise detected. Accordingly, when interference or other symptom of interference is detected a co-existence issue may be detected. In particular embodiments, the interference level (e.g., de-sense level) is based on (i) a frequency separation between a transmit channel of the transmitter and receive channel of the receiver and (ii) transit power of the transmitter.

In some embodiments, parameters of the detected co-existence issue may also be determined, for example, by the controller 230. For instance, the controller 230 may determine the parameters, such as the coupling channel gains, the frequency (e.g., f1), delay (e.g., d1), and/or the like of the aggressor transmitter. For example, if the first transmitter 412 is a WiFi transmitter, the first frequency f1 may be about 2.4 GHz and the first delay may be (but is not limited to) about 15 ns. For example, if the second receiver 424 is a Bluetooth receiver, the first frequency f1 may be about 2.4 GHz and the second delay may be about 15 ns. If the co-existence issue is between the first transmitter and the second receiver 324, the overall IC parameters are coupling channel gain −10 dB at 2.4 GHz and the overall delay is 30 ns. In particular embodiments, the controller 230 may correspond to a LMS coefficient controller and/or the LMS coefficient controller 460 may be provided to determine the parameters.

The first transmitter 412 is electrically coupled to a first antenna 401. The first transmitter 412 transmits communication signals along a first transmit path 413 via the first antenna 401. In some embodiments, a power amplifier (not shown) for amplifying signals transmitted by the first transmitter 412 may also be provided.

At block B520, the first transmitter 412, which was determined to have a co-existence issue with the first receiver 424 (e.g., at block B510), is coupled to the IC 220. For instance, an input MUX 452 (which may correspond, for example, to the input MUX 352) may select the first transmitter 412 to provide a signal 411 transmitted by the first transmitter 412 as an input signal 456 (which may correspond, for example, to the input signal 356) to the IC 220.

In some embodiments, the input signal 456 to the IC circuit 220 is coupled to the first transmit path 413 via a coupler 416 and the input MUX 452. The coupler 416 obtains samples of signals (signal 411) transmitted by the first transmitter 412 and provides the samples to the input MUX 452, which then provides the samples as the input signal 456 to the IC circuit 220. Accordingly, the coupler 416 can obtain a sample or a representation of the interference of the aggressor signal transmitted by the first transmitter 412, which produces, induces, generates, or otherwise causes the interference. In certain embodiments, the coupler 416 provides a direct connection to the first transmit path 413. Alternatively, a capacitor, resistor, antenna, or other device could be used in place of or in addition to the coupler 416 to obtain samples of the signals transmitted by the first transmit path 413.

At block B530, the first receiver 424, which was determined to have a co-existence issue with the first transmitter 412 (e.g., at block B510), is selected. The first receiver 424 is electronically coupled to a second antenna 403. The first receiver 424 receives a signal d(t)+g(t)+n(t), where d(t) is the aggressor signal from the first transmitter 412, g(t) is the signal of the wireless coupling path, and n(t) is noise, along a first receiver path 414 via the second antenna 403.

Each of the plurality of receivers 314, 324, 334, 344 may include a corresponding filter for filtering a signal received by its respective receiver to provide a corresponding filtered signal. For instance, a MUX (not shown) may select the first receiver 424 (as determined to have a co-existence issue) to provide a signal 414 received by the first receiver 424 (e.g., via antenna 403) to a filter 404 corresponding to the first receiver 424. The filter 404 may filter the signal 414 to provide a first filtered signal 417. One or more of the filters 404 may be a band pass filter (BPF), duplexer, notch filter, and/or the like.

In other embodiments, the filter 404 is a tunable filter that is tuned based on the co-existence issue. For instance, for a first type of co-existence issue (e.g., WiFi transmitter with Bluetooth receiver), the filter 404 may be tuned to have a first set of characteristics (e.g., gain, delay, etc.) and a second set of characteristics for a second type of co-existence issue.

It should be noted that the co-existence combination between the transmitter 412 (312) and the receiver 424 (324) is merely exemplary and that the controller 230 is configured to select from among other combinations (e.g., the first transmitter 312 with the third receiver 334 and/or the n-th receiver 344; the second transmitter 322 and the first receiver 314, the third receiver 334, and/or the n-th receiver 344; the third transmitter 332 and the first receiver 314, the second receiver 324, and/or the n-th receiver 344; the n-th transmitter 342 and the first receiver 314, the second receiver 324, and/or the third receiver 334) based on co-existence issues between such combinations.

At block B540, in various embodiments, the IC circuit 220 is configured (e.g., by the LMS controller 460), for example, based on the parameters of the co-existence issue. For instance, this may be performed by measuring interference level at the receiver 424 or from pre-defined table. In some embodiments, if a significant amount of interference is detected, the controller (e.g., controller 230) determines the radio of interest (i.e., the radio involved with the co-existence issue) and switch the input and output MUXs to choose the signal of interest. The waveform-agnostic common IC circuit 220 is used for various set of aggressor and victim radios. Accordingly, the IC circuit 220 may begin updating LMS coefficient(s) to cancel the interference. In some embodiments, one or more pre-defined initial parameter values may also be used for the LMS coefficient(s) at the IC circuit 220 until the IC circuit 220 enters a steady state. Accordingly, at block B550, the IC circuit 220 may generate an output signal 458 (which may correspond, for example, to the output signal 358) based on the input signal 456 and the parameters of the co-existence issue.

The interference cancellation (IC) circuit 220 is configured to generate the output signal 458 to cancel (reduce) interference (e.g., in-band and/or nearby out-of-band interference) introduced onto the first receive path 414 by signals transmitted along the first transmit path 413 (by the first transmitter 412). In various embodiments, the IC circuit 220 is configured by the controller 230 based on the parameters (e.g., frequency, delay, etc.) of the detected co-existence issue.

The IC circuit 220 adjusts the amplitude, phase, and/or delay of the sampled signals to produce an interference compensation signal (e.g., output signal 458) that, when applied (e.g., via adder 426) to the first receive path 414 of the second receiver 424, reduces, suppresses, or cancels the amplitude of in-band and/or nearby out-of-band interference and/or noise introduced onto the first receive path 414 by signals transmitted along the first transmit path 413. In particular embodiments, the IC circuit 220 adjusts the amplitude, phase, and/or delay of the sampled signals based on settings received from another device, such as an LMS coefficient controller 460 (and/or the controller 230).

In some embodiments, the IC circuit 220 comprises a single-tap least-mean square (LMS) adaptive filter 450. The LMS adaptive filter 450 may receive the input signal 456 and generate the output signal 458. It should be noted that in other embodiments, an LMS filter having any number of taps (e.g., three taps) may be implemented. In some embodiments, the LMS adaptive filter 450 implements analog methods. Analog methods, for example, allow for wideband interference cancellation. In other embodiments, the LMS adaptive filter 450 implements digital methods. Digital methods, for example, may provide a good tradeoff between main lobe and side lobe cancellation. In some embodiments, an amplifier 451 may be provided to amplify a signal generated by the LMS adaptive filter 450 to generate the output signal 458.

In some embodiments, a plurality of filters may be coupled to an output DEMUX 454 (which may correspond, for example, to the output DEMUX 354) to receive corresponding signals 415, 425, 435, 445 (which may correspond to signals 315, 325, 335, 345, respectively) from the output DEMUX 454. The output DEMUX 454 is coupled to the IC circuit 220 to allow the output DEMUX 454 to select (e.g., as controlled by the controller 230) a filter from among the plurality of filters, to receive the output signal 458 from the IC circuit 220. Accordingly, at block B560, a filter 402 is selected based on parameters of the filter 404 associated with the first receiver 424. The filter 402 receives the output signal 458 from the IC circuit 220 to provide a second filtered signal 418. One or more of the filters 402 may be a band pass filter (BPF), duplexer, notch filter, and/or the like.

In some embodiments, the filter 402 is selected from among a plurality of filters. For instance, the plurality of filters may include a corresponding filter for each of the receiver filters. In other embodiments, a single (or more) filter 402 is configured to match characteristics of the filter 404. For instance, the filter 402 may be a tunable filter that is tuned to match the characteristics, (e.g., gain, delay, etc.) of the filter 404. For instance, if the filter 404 has a first characteristic (or set of characteristics), the filter 402 is tuned to have the first characteristic, and if the filter 404 has a second characteristic, the filter 402 is tuned to have the second characteristic.

Thus in various embodiments, for a given co-existence issue, the system 400 includes two identical filters: the filter 404 in the wireless coupling path 410 and the filter 402 in the IC path 420 to minimize delay (and/or gain) mismatch between the two paths 410, 420. Because in some embodiments, the filter 402 may be the main source of the group delay in the IC path 420, using an identical filter 404 in the coupling path 410 can minimize the delay difference between the two paths 410, 420. In particular, the filter 402 in the IC path 420 can be selected or otherwise adjusted, for instance using the output DEMUX 454 to match the filter 404 associated with the receiving radio (in the wireless coupling path 410). For example, if the victim radio is a first victim radio associated with a first filter (e.g., BPF1), the output DEMUX 454 selects a similar filter (e.g., BPF1) in the IC path 420, and if the victim radio is a second victim radio associated with a second filter (e.g., BPF2), the DEMUX 454 selects a similar filter (e.g., BPF2) in the IC path 420.

At block B570, a cancellation signal 419 is generated based on the first filtered signal 417 and the second filtered signal 418 to reduce interference caused by the first transmitter 412 on the first receiver 424. For instance, an adder 426 receives the first filtered signal 417 and the second filtered signal 418 to generate the cancellation signal 419.

In some embodiments, the cancellation signal 419 may be provided to a low-noise amplifier (LNA) 427. The LMS coefficient controller 460 receives a signal 429 from the LNA 427 to determine parameters (coefficients) for the IC circuit 220.

In some embodiments, the LNA 427 may be coupled to a mixer 431. An output of the mixer 431 may be coupled to an analog-to-digital converter (ADC) 433. An output of the ADC 433 may be coupled to one or more digital filters 435. An output of the digital filter 435 may be coupled to a digital signal processor (DSP) 437 that generates an output coupled to a software block (S/W) 439. In some embodiments, the S/W 439 may include a timer to periodically switch between a first mode (a normal operation mode) and a second mode (an IC monitoring mode). An output of the S/W 439 may be coupled to digital-to-analog converter (DAC) 441. An output of the DAC 441 may be coupled to the LMS coefficient controller 460. Accordingly, for example, the LMS coefficient controller 460 provide configuration information to the IC circuit 220 (e.g., LMS adaptive filter 450), via the update path 462, based on the signal 429 and the output of the DAC 441. That is, the LMS coefficient controller 460 may control a signal along the update path 462 based on gain, delay, and/or frequency mismatch between the coupling path 410 and the IC path 420 to minimize error before the LNA 427. In various embodiments, the configuration information (e.g., coefficients) from the LMS coefficient controller 460 may be used to configure the IC circuit 220 (e.g., LMS adaptive filter 450) to generate an updated output signal 458, which then may be filtered by the filter 404 to provide an updated second filtered signal 418 (g(t)+n′(t), where n′(t) is noise along the IC path 420) to generate a new cancellation signal 419 (d(t)+n(t)−n′(t)).

In some embodiments, a co-existence issue may exist or be detected between more than two transceivers. Accordingly, multiple IC circuits 220 may be implemented for concurrent interference cancellation.

In some embodiments, the processing system 201 may selectively ignore or otherwise not manage a particular co-existence issue (e.g., via the IC circuit 220 and/or the controller 230) under certain circumstances. For example, the processing system 201 may selectively ignore or otherwise not manage the particular co-existence issue if the processing system 201 (e.g., the controller 230) determines that the particular co-existence issue is being managed by a different method and/or system. If the co-existence issue is managed by a baseband IC circuitry, the processing system 201 may not manage the issue with an analog IC circuitry. As another example, the processing system 201 may selectively ignore or otherwise not manage the particular co-existence issue if the processing system 201 (e.g., the controller 230) determines that the particular co-existence issue is below a specified threshold. For instance, the particular co-existence issue may be ignored if the issue causes light interference (e.g., a few decibels). That is, the co-existence issue may be ignored (or otherwise unmanaged) if an intensity of the interference is below a predetermined threshold. For example, if the interference is less than 10 dB above a sensitivity level of the receiver, the co-existence issue may be ignored.

The method B500 described in FIG. 5A above may be performed by various hardware and/or software component(s) and/or module(s) corresponding to the means-plus-function blocks B500′ illustrated in FIG. 5B. In other words, blocks B510 through B570 illustrated in FIG. 5A correspond to means-plus-function blocks B510′ through B570′ illustrated in FIG. 5B.

It is understood that the specific order or hierarchy of steps in the processes disclosed is an example of illustrative approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the implementations disclosed herein may be implemented as electronic hardware, computer software embodied on a tangible medium, or combinations of both. To clearly illustrate this interchangeability of hardware and software, various illustrative components, blocks, modules, circuits, and steps have been described above generally in terms of their functionality. Whether such functionality is implemented as hardware or software embodied on a tangible medium depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An illustrative storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more illustrative implementations, the functions described may be implemented in hardware, software or firmware embodied on a tangible medium, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media.

The previous description of the disclosed implementations is provided to enable any person skilled in the art to make or use the present disclosure. Various modifications to these implementations will be readily apparent to those skilled in the art, and the generic principles defined herein may be applied to other implementations without departing from the spirit or scope of the disclosure. Thus, the present disclosure is not intended to be limited to the implementations shown herein but is to be accorded the widest scope consistent with the principles and novel features disclosed herein.

1. A method of performing interference cancellation in a communication device having a plurality of transmitters and a plurality of receivers, the method comprising:
detecting a co-existence issue between a first transmitter of the plurality of transmitters and a first receiver of the plurality of receivers;
selecting the first transmitter for providing an input signal to an interference cancellation (IC) circuit;
selecting the first receiver, wherein each of the receivers has a corresponding filter, the first receiver having a filter for filtering a signal received by the first receiver to provide a first filtered signal;
configuring the IC circuit based on parameters of the co-existence issue;
generating, at the IC circuit, an output signal based on the input signal and the parameters of the co-existence issue;
selecting a filter, based on the filter of the first receiver, configured to receive the output signal of the IC circuit, the selected filter configured to filter the output signal to provide a second filtered signal; and
generating a cancellation signal based on the first filtered signal and the second filtered signal to reduce interference caused by the first transmitter on the first receiver.

2. The method of claim 1, wherein the selected filter is selected to be identical to the filter of the first receiver.

3. The method of claim 1, wherein the selected filter is selected to provide a delay on an IC path along which the IC circuit is located that is the same as a delay on a coupling path between an antenna of the first transmitter and an antenna of the first receiver.

4. The method of claim 1, wherein the filter of the first receiver comprises at least one of a band pass filter, a duplexer, and a notch filter.

5. The method of claim 1, wherein the selected filter comprises at least one of a band pass filter, a duplexer, and a notch filter.

6. The method of claim 1, wherein the IC circuit comprises an adaptive filter.

7. The method of claim 6, wherein the adaptive filter comprises a lease mean squares (LMS) adaptive filter.

8. The method of claim 7, wherein the LMS adaptive filter comprises an analog-controlled analog LMS adaptive filter.

9. The method of claim 7, wherein the LMS adaptive filter comprises a digitally-controlled analog LMS adaptive filter.

10. The method of claim 6, wherein the adaptive filter comprises a single-tap filter.

11. The method of claim 1, wherein the selecting a filter comprises selecting a filter from among a plurality of filters.

12. The method of claim 1, wherein the selecting a filter comprises configuring the filter based on the filter of the first receiver.

13. The method of claim 1, wherein the first transmitter and the first receiver are selected based on the co-existence issue between the first transmitter and the first receiver.

14. The method of claim 1, the method further comprising:
detecting a second co-existence issue between the first transmitter of the plurality of transmitters and a second receiver of the plurality of receivers;
selecting the first transmitter for providing a second input signal to the IC circuit;
selecting the second receiver, the second receiver having a filter for filtering a signal received by the second receiver to provide a third filtered signal;
configuring the IC circuit based on the parameters of the second co-existence issue;
generating, at the IC circuit, a second output signal based on the second input signal and the parameters of the second co-existence issue;
selecting a filter, based on the filter of the second receiver, from among the plurality of filters configured to receive the second output signal of the IC circuit, the selected filter configured to filter the second output signal to provide a fourth filtered signal; and
generating a cancellation signal based on the third filtered signal and the fourth filtered signal to reduce interference caused by the first transmitter on the second receiver.

15. The method of claim 1, the method further comprising:
detecting a second co-existence issue between a second transmitter of the plurality of transmitters and a second receiver of the plurality of receivers;
selecting the second transmitter for providing a second input signal to the IC circuit;
selecting the second receiver, the second receiver having a filter for filtering a signal received by the second receiver to provide a third filtered signal;
configuring the IC circuit based on the parameters of the second co-existence issue;
generating, at the IC circuit, a second output signal based on the second input signal and the parameters of the second co-existence issue;
selecting a filter, based on the filter of the second receiver, from among the plurality of filters configured to receive the second output signal of the IC circuit, the selected filter configured to filter the second output signal to provide a fourth filtered signal; and
generating a cancellation signal based on the third filtered signal and the fourth filtered signal to reduce interference caused by the second transmitter on the second receiver.

16. The method of claim 1,
wherein the first transmitter transmits signals on a frequency within a first frequency band;
wherein the first receiver receives signals at a frequency within a second frequency band; and
wherein the first frequency band at least partially overlaps the second frequency band.

17. The method of claim 1,
wherein the first transmitter transmits signals on a frequency within a first frequency band;
wherein the first receiver receives signals at a frequency within a second frequency band; and
wherein the first frequency band is adjacent the second frequency band.

18. The method of claim 1,
wherein the first transmitter transmits signals at a frequency within a first frequency band;
wherein the first receiver receives signals at a frequency within a second frequency band; and
wherein the first frequency band is a non-adjacent lower frequency band.

19. The method of claim 18, wherein the first frequency band includes a sub-harmonic frequency of the second frequency band.

20. The method of claim 1,
wherein the first transmitter transmits signals at a frequency within a first frequency band;
wherein the first receiver receives signals at a frequency within a second frequency band; and
wherein the first frequency band includes a non-adjacent higher frequency band.

21. The method of claim 20, wherein the first frequency band includes a harmonic frequency of the second frequency band.

22. The method of claim 1, the method further comprising:
detecting an intensity of the interference caused by the first transmitter on the first receiver;
wherein the co-existence issue is not detected if the intensity is below a predetermined threshold.

23. The method of claim 1, wherein at least one receiver of the plurality of receivers is configured to receive navigation signals.

24. The method of claim 1, wherein the detecting a co-existence issue comprises measuring an interference level at the first receiver.

25. The method of claim 24, wherein the interference level is based on (i) a frequency separation between a transmit channel of the first transmitter and receive channel of the first receiver and (ii) transit power of the transmitter.

26. The method of claim 25, wherein the detecting a co-existence issue comprises comparing the interference level with a pre-defined table.

27. The method of claim 1, wherein the detecting a co-existence issue comprises measuring transmission information obtained at the transmitter.

28. The method of claim 1, wherein the detecting a co-existence issue comprises detecting a co-existence issue based on a pre-defined table.

29. The method of claim 1, wherein the detecting a co-existence issue comprises measuring transmission information obtained at the transmitter.

30. The method of claim 1, wherein the method is not performed if the co-existence issue is not detected.

31. An apparatus for reducing interference in a communication device having a plurality of transmitters and a plurality of receivers, the apparatus comprising:
means for detecting a co-existence issue between a first transmitter of the plurality of transmitters and a first receiver of the plurality of receivers;
means for selecting the first transmitter for providing an input signal to an interference cancellation (IC) circuit;
means for selecting the first receiver, wherein each of the receivers has a corresponding filter, the first receiver having a filter for filtering a signal received by the first receiver to provide a first filtered signal;
means for configuring the IC circuit based on parameters of the co-existence issue;
means for generating, at the IC circuit, an output signal based on the input signal and the parameters of the co-existence issue;
means for selecting a filter, based on the filter of the first receiver, configured to receive the output signal of the IC circuit, the selected filter configured to filter the output signal to provide a second filtered signal; and
means for generating a cancellation signal based on the first filtered signal and the second filtered signal to reduce interference caused by the first transmitter on the first receiver.

32. A computer program product for reducing interference in a communication device having a plurality of transmitters and a plurality of receivers, the computer program product comprising one or more non-transitory computer-readable storage media comprising code for causing one or more computers to:
detect a co-existence issue between a first transmitter of the plurality of transmitters and a first receiver of the plurality of receivers;
select the first transmitter for providing an input signal to an interference cancellation (IC) circuit;
select the first receiver, wherein each of the receivers has a corresponding filter, the first receiver having a filter for filtering a signal received by the first receiver to provide a first filtered signal;
configure the IC circuit based on parameters of the co-existence issue;
generate, at the IC circuit, an output signal based on the input signal and the parameters of the co-existence issue;
select a filter, based on the filter of the first receiver, configured to receive the output signal of the IC circuit, the selected filter configured to filter the output signal to provide a second filtered signal; and
generate a cancellation signal based on the first filtered signal and the second filtered signal to reduce interference caused by the first transmitter on the first receiver.

33. A system for performing interference cancellation in a communication device, the system comprising:
an input multiplexer (MUX) configured to select a transmitter from among a plurality of transmitters;
an interference cancellation (IC) circuit configured to receive an input signal from the selected transmitter of the plurality of transmitters to generate an output signal;
a demultiplexer (DEMUX) configured to select a receiver from among a plurality of receivers, each of the receivers associated with a corresponding filter, the filter of the selected receiver for filtering a signal received by the selected receiver to provide a first filtered signal, the DEMUX configured to select a filter from among a plurality of filters, based on the filter of the selected receiver, the selected filter for filtering the output signal to provide a second filtered signal; and
a summer configured to combine the first filtered signal and the second filtered signal to provide a cancellation signal to reduce interference caused by the selected transmitter on the selected receiver.

34. A system for performing interference cancellation in a communication device having a plurality of receivers and a plurality of transmitters, the system comprising:
a plurality of receiver filters, each of the receiver filters associated with a corresponding receiver of the plurality of receivers, the filter of a selected receiver for filtering a signal received by the selected receiver to provide a first filtered signal;
an interference cancellation (IC) circuit configured to receive an input signal from a selected transmitter of the plurality of transmitters to generate an output signal;
a plurality of transmitter filters, a selected transmitter filter for filtering the output signal to provide a second filtered signal, wherein the selected transmitter filter is selected from among the plurality of filters based on the filter of the selected receiver; and
a summer configured to combine the first filtered signal and the second filtered signal to provide a cancellation signal to reduce interference caused by the selected transmitter on the selected receiver.
